(19) United States
(12) Patent Application Publication
(10) Pub. No.: US 2019/0180789 A1
(43) Pub. Date: Jun. 13, 2019

(54) IMAGE PROCESSING APPARATUS, CONTROL METHOD OF IMAGE PROCESSING APPARATUS, AND NON-TRANSITORY COMPUTER READABLE MEDIUM

(71) Applicant: CANON KABUSHIKI KAISHA, Tokyo (JP)

(72) Inventor: Toshitaka Aiba, Tokyo (JP)

(21) Appl. No.: 16/213,051

(22) Filed: Dec. 7, 2018

(30) Foreign Application Priority Data
Dec. 11, 2017 (JP) 2017-237052

(51) Int. Cl. G11B 27/30; G11B 27/031

(52) U.S. Cl. CPC G11B 27/3081; G11B 27/031

(57) ABSTRACT

An image processing apparatus includes: a display control unit displays an image based on first still image data which is extracted from video data and saved; a first determination unit determines source video data, which is extraction source of the first still image data; a second determination unit determines a first frame position corresponding to the first still image data in the video data; an input reception unit receives an instruction to acquire second still image data of a second frame position in the video data, the second frame position being different from the first frame position; and an acquisition unit acquires the second still image data, wherein the display control unit switches the image to be displayed on a display unit to an image based on the second still image data in response to acquisition of the second still image data.

### BACKGROUND OF THE INVENTION

### Field of the Invention

The present invention relates to an image processing apparatus, a control method of an image processing apparatus, and a non-transitory computer readable medium.

### Description of the Related Art

In recent years, a function of extracting any frame specified by a user from video data and saving the frame as still image data, has been proposed.

In Japanese Patent Application Publication No. 2016-082546, raw video data (RAW image) shot by using an image pickup apparatus and video data (proxy video data) subjected to compression coding are retained, and the proxy video data is used in the case where reproduction or editing of a video is performed, and the original RAW image is used in the case where a frame is extracted. As a result, the speed of the reproduction or editing of the video can be increased, and high-quality still image data can be extracted.

However, in the case where a frame different from still image data that has been extracted and saved is extracted from video data, a user needs to reopen a video file and reselect a new frame, which is burdensome for the user.

### SUMMARY OF THE INVENTION

An object of the present invention is to provide a technique capable of avoiding the trouble of reselecting the frame from the video data in the case where a frame different from still image data that has been extracted from video data and has been saved is acquired.

The present invention in its first aspect provides an image processing apparatus comprising:

a display control unit configured to perform control so as to display an image based on first still image data on a display unit, the first still image data being extracted from video data and saved;

a first determination unit configured to determine source video data, which is extraction source of the first still image data;

a second determination unit configured to determine a first frame position corresponding to the first still image data in the video data;

an input reception unit configured to receive an acquisition instruction to acquire second still image data of a second frame position in the video data, the second frame position being different from the first frame position; and

an acquisition unit configured to acquire the second still image data according to the acquisition instruction,

wherein the display control unit is further configured to switch the image to be displayed on the display unit to an image based on the second still image data in response to acquisition of the second still image data.

The present invention in its second aspect provides an control method of an image processing apparatus, the control method comprising:

performing control so as to display an image based on first still image data on a display unit, the first still image data being extracted from video data and saved;

determining source video data, which is extraction source of the first still image data;

determining a first frame position corresponding to the first still image data in the video data;

receiving an acquisition instruction to acquire second still image data of a second frame position in the video data, the second frame position being different from the first frame position;

acquiring the second still image data according to the acquisition instruction; and

switching the image to be displayed on the display unit to an image based on the second still image data in response to acquisition of the second still image data.

The present invention in its third aspect provides a non-transitory computer readable medium that stores a program, wherein the program causes a computer to execute: a control method of an image processing apparatus, the control method comprising:

performing control so as to display an image based on first still image data on a display unit, the first still image data being extracted from video data and saved;

determining source video data, which is extraction source of the first still image data;

determining a first frame position corresponding to the first still image data in the video data;

receiving an acquisition instruction to acquire second still image data of a second frame position in the video data, the second frame position being different from the first frame position;

acquiring the second still image data according to the acquisition instruction; and

switching the image to be displayed on the display unit to an image based on the second still image data in response to acquisition of the second still image data.

Further features of the present invention will become apparent from the following description of exemplary embodiments with reference to the attached drawings.

### BRIEF DESCRIPTION OF THE DRAWINGS

FIG. 1 is a functional block diagram showing an example of an image processing apparatus according to an embodiment;

FIG. 2 is a functional block diagram showing an example of a control unit of the image processing apparatus according to the embodiment;

FIG. 3 is a flowchart showing an example of a extraction process of still image data according to the embodiment;

FIG. 4 is a view showing an example of a file structure of the still image data according to the embodiment;

FIGS. 5A and 5B are views each showing an example of a still image editing screen according to the embodiment; and

FIG. 6 is a flowchart showing an example of an image editing process according to the embodiment.

### DESCRIPTION OF THE EMBODIMENTS

### Embodiment

Hereinbelow, an embodiment of the present invention will be described.

An image processing apparatus according to the present embodiment is an apparatus that performs display and editing of still image data (first still image data) obtained by extracting a frame from video data and saving the frame (first frame). In addition, the image processing apparatus acquires a new frame (second frame) different from a display and edit subject frame from source video data according to an instruction of a user, and performs the display and editing of the new frame. In the present embodiment, the user extracts a frame from video data by using an image capturing apparatus that is separate from the image processing apparatus. Subsequently, the extracted frame saved as still image data in the image capturing apparatus and the source video data are imported into the image processing apparatus, and the display and editing described above are performed on the image processing apparatus by the user. Hereinbelow, the overall configuration of the image processing apparatus according to the present embodiment, a extraction process of the still image data, and an image editing process will be described one by one.

<Overall Configuration>

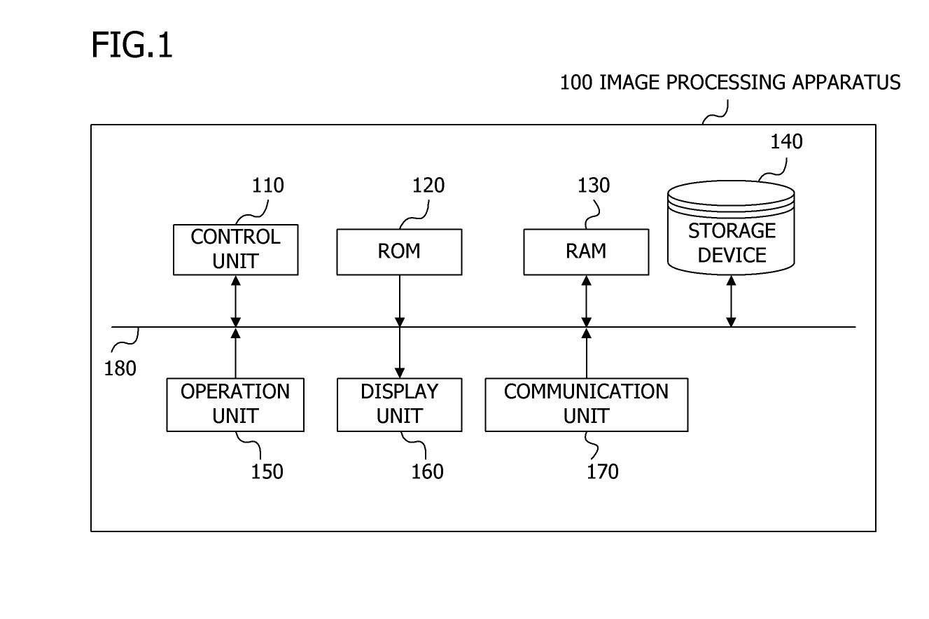

FIG. 1 is a configuration diagram showing an example of an image processing apparatus 100 according to the present embodiment. The image processing apparatus 100 includes a control unit 110, a read-only memory (ROM) 120, a random-access memory (RAM) 130, a storage device 140, an operation unit 150, a display unit 160, a communication unit 170, and a system bus 180.

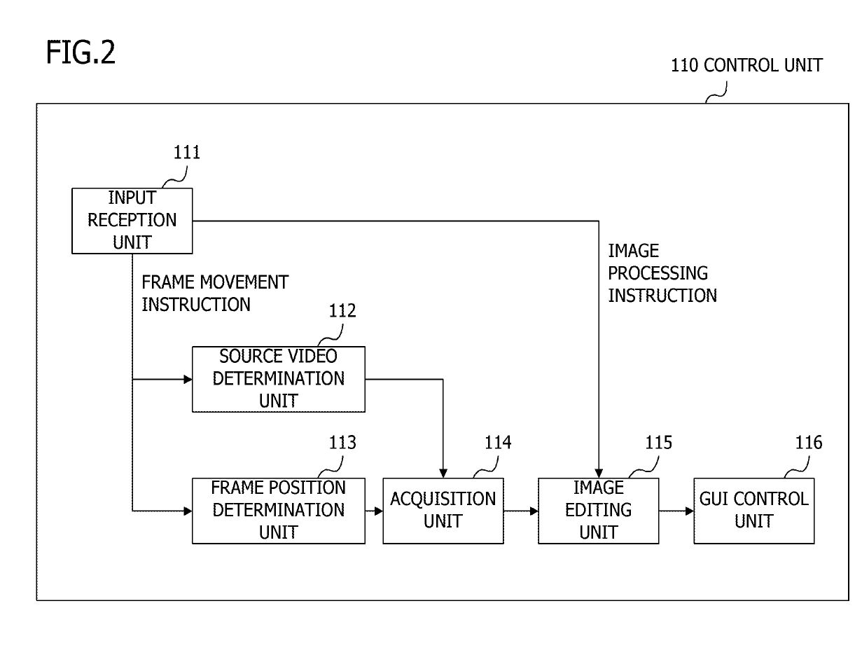

The control unit 110 is a functional unit that controls the overall operation of the image processing apparatus 100, and is, e.g., a central processing unit (CPU). The control unit 110 provides each functions described later by performing processes according to input signals and various programs. The detail of the control unit 110 will be described later by using FIG. 2. Note that, as the control unit 110, one piece of hardware may be used or a plurality of pieces of hardware may also be used. A plurality of pieces of hardware share and execute processes, and the operation of the image processing apparatus 100 may be thereby controlled.

The ROM 120 is a storage unit that non-transitorily stores programs, parameters, and various pieces of data that do not need to be changed. The ROM 120 stores various programs used in the entire image processing apparatus 100 (the startup program (BIOS) of the image processing apparatus 100 and the like). When the image processing apparatus 100 is started, the control unit 110 reads the startup program from the ROM 120, and writes the read startup program into the RAM 130 described later. Subsequently, the control unit 110 executes the startup program written into the RAM 130.

The RAM 130 is a storage unit that transitorily stores programs and various pieces of data that are supplied from an external device or the like. The RAM 130 is used for, e.g., processes of the control unit 110.

The storage device 140 is a device capable of storing various pieces of data. The storage device 140 stores, e.g., various files of the still image data and the video data described above, and control programs of the image processing apparatus 100 (programs of applications that operate in the image processing apparatus 100 and the like). When the user issues an instruction to execute the control program, the control unit 110 reads the control program from the storage device 140, and writes the read control program into the RAM 130. Subsequently, the control unit 110 executes the control program written into the RAM 130. As the storage device 140, it is possible to use recording media such as semiconductor memories (a memory card, an IC card), magnetic disks (a FD, a hard disk), and optical disks (a CD, a DVD, a Blu-ray Disc). Note that the storage device 140 may be a storage unit attachable to and detachable from the image processing apparatus 100, and may also be a storage unit that is incorporated in the image processing apparatus 100. The image processing apparatus 100 includes the function of accessing the storage device 140, reading data from and writing data into the storage device 140, and deleting data stored in the storage device 140.

The operation unit 150 is a functional unit that receives a user operation to the image processing apparatus 100. The operation unit 150 outputs an operation signal corresponding to the user operation to the control unit 110. Subsequently, the control unit 110 performs a process corresponding to the operation signal. That is, the control unit 110 performs the process corresponding to the user operation to the image processing apparatus 100. As the operation unit 150, it is possible to use input devices such as, e.g., a physical button, a touch panel, a keyboard, and a mouse. In addition, as the operation unit 150, it is also possible to use input devices separate from the image processing apparatus 100 such as, e.g., a keyboard, a mouse, and a remote control unit. The image processing apparatus 100 has the function of receiving an electrical signal corresponding to the user operation that uses the input device.

The display unit 160 (display unit) is a functional unit that displays an image on a screen. The display unit 160 displays images based on the still image data, and graphic images for interactive operations (graphical user interface (GUI) images, characters, icons). As the display unit 160, it is possible to use display devices such as, e.g., a liquid crystal display panel, an organic EL display panel, a plasma display panel, and an MEMS shutter display panel. The display unit 160 may also be a touch monitor provided with a touch panel. Note that, as the display unit 160, an image display apparatus separate from the image processing apparatus 100 may also be used. The image processing apparatus 100 has the function of controlling the display of the display unit 160.

The communication unit 170 connects the image processing apparatus 100 to an external device and performs communication between the image processing apparatus 100 and the external device. Note that the communication unit 170 may connect the image processing apparatus 100 to the external device by using wired communication that uses a universal serial bus (USB) cable or the like. The communication unit 170 may connect the image processing apparatus 100 to the external device by using wireless communication that uses a wireless LAN.

The system bus 180 is a functional unit that is used in transmission and reception of data (connection) between units such as the control unit 110, the ROM 120, the RAM 130, the storage device 140, the operation unit 150, the display unit 160, and the communication unit 170.

In the present embodiment, the user captures a video by using an image capturing apparatus (not shown) such as a digital video camera, and selects any frame from video data obtained by capturing. With this, the selected frame is saved in the image capturing apparatus as a file separate from a video file. Subsequently, data obtained by capturing is imported into the image processing apparatus 100 from the image capturing apparatus by the user. Communication between the image capturing apparatus and the image processing apparatus 100 is performed in the following manner. First, when the user issues an instruction to connect the image capturing apparatus and the image processing apparatus 100, the control unit 110 reads a communication program from the storage device 140, and writes the read communication program into the RAM 130. Subsequently, the control unit 110 executes the communication program written into the RAM 130. With this, the following processes are performed.

First, the connection between the image processing apparatus 100 and the image capturing apparatus is established. Next, the control unit 110 issues an instruction to transmit the video data and the still image data to the image capturing apparatus via the communication unit 170. Subsequently, the image capturing apparatus transmits the target video data and the target still image data to the image processing apparatus 100. Then, the control unit 110 receives the video data and the still image data transmitted from the image capturing apparatus via the communication unit 170. Further, the control unit 110 records the received data in the storage device 140 as the video file and a still image file. Note that the communication between the image capturing apparatus and the image processing apparatus 100 may be performed by using wired connection, and may also be performed by using wireless connection.

Note that extraction of the still image data may be performed without using the image capturing apparatus. For example, the video data may be imported into the image processing apparatus 100 from the image capturing apparatus by the user, and the still image data may be extracted on the image processing apparatus 100. In addition, the video data may be imported into an external device such as a smartphone or a PC by the user, and the still image data may be extracted. The apparatus for capturing the video is not limited to the video camera or the like. The user may capture the video by using an external device such as, e.g., a smartphone or a PC.

<Each Functional Sections of Control Section>

FIG. 2 is a functional block diagram showing an example of the control unit 110 according to the present embodiment. The control unit 110 according to the present embodiment includes an input reception unit 111, a source video determination unit 112, a frame position determination unit 113, an acquisition unit 114, an image editing unit 115, and a GUI control unit 116 (display control unit).

The input reception unit 111 is a functional unit that receives an input according to the user operation in a still image editing screen (GUI) described later. Examples of the user operation include a button operation and a slider operation on the GUI.

The source video determination unit 112 (first determination unit) is a functional unit that determines source video data (capture-source video data) based on the metadata or the file name of the still image data (first still image data) extracted from the video data. For example, the source video determination unit 112 determines the capture-source video data by acquiring the file name of the capture-source video data from the above-mentioned metadata.

The frame position determination unit 113 (second determination unit) is a functional unit that determines a frame (first frame) position corresponding to the still image data in source video data based on the metadata or the file name of the extracted still image data mentioned above.

The acquisition unit 114 is a functional unit that acquires the frame (second frame) based on a movement instruction from the source video data according to the user operation. For example, in the case where the acquisition unit 114 is instructed to acquire a frame immediately subsequent to the extracted still image data, the acquisition unit 114 acquires the frame immediately subsequent to the extracted frame from the video data determined by the above-described source video determination unit 112.

The image editing unit 115 is a functional unit that performs image editing of the still image data extracted from the video. Specifically, the image editing unit 115 performs the image editing such as brightness adjustment and noise removal of the still image data, and save of an adjusted file according to the user operation performed via the GUI.

The GUI control unit 116 is a functional unit that performs display of an image in a display area described later and switches the image to the image of the frame acquired by the acquisition unit 114.

<Extraction Process of Still Image Data>

### <<Process Detail>>

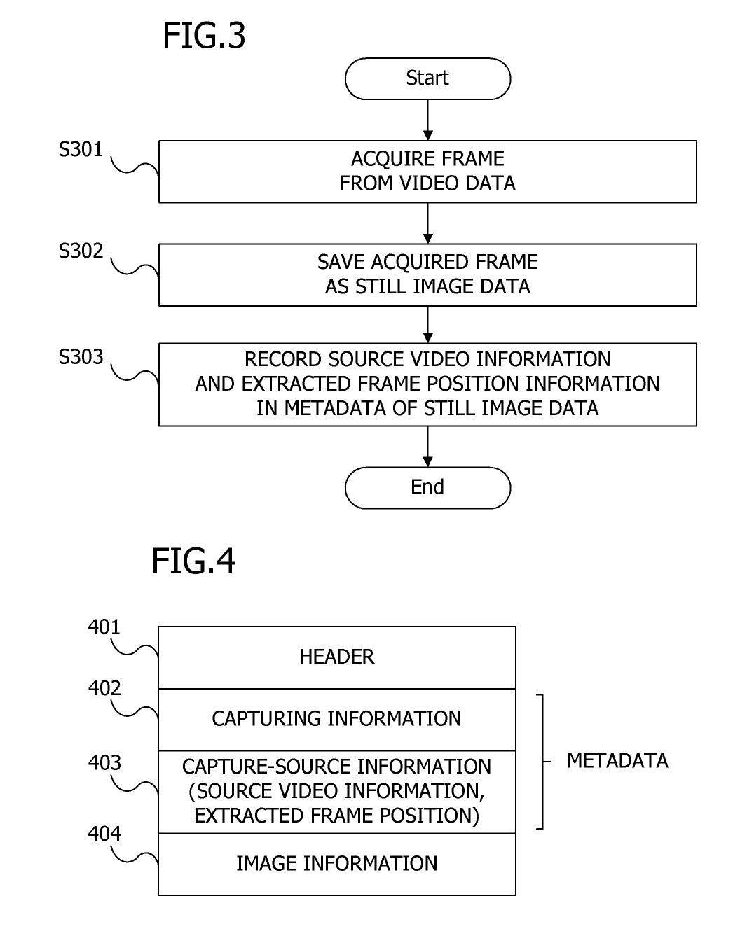

FIG. 3 is a flowchart showing an example of a extraction process of the still image data from the video data according to the present embodiment. By using the flowchart in FIG. 3, a description will be given of a process in which the image capturing apparatus extracts the frame specified by the user from the video data and saves the extracted frame, and information related to the source video (the file name of the source video or the like) is added to the metadata of the still image data.

The user operates the image capturing apparatus to issue an instruction to save the still image data corresponding to any frame in the video data, and the extraction process of the image according to the present embodiment is thereby started. An instruction to extract the still image data from the video data is an operation that is commonly performed in a digital video camera or a PC, and hence the description thereof will be omitted.

First, the image capturing apparatus acquires the frame specified by the user from the video data (S301). Subsequently, the image capturing apparatus saves the acquired frame as the still image data (S302). Herein, the image capturing apparatus saves information on the capture-source video data and extracted frame position information in the metadata of the saved still image data (S303). In the present embodiment, the image capturing apparatus saves the file name of the video data as source video data information in the metadata together with the extracted frame position information.

Note that the extraction process of the still image data may be automatically performed. For example, the image capturing apparatus may automatically save the frame as the still image data at predetermined time intervals. The capture-source video data is assumed to be placed in the same directory as that of the still image data, but may also be placed in a different directory. In the case where the capture-source video data is placed in the different directory, the source video determination unit 112 may acquire the place in which the source video data is placed based on the metadata of the extracted still image data. In addition, a correspondence between the source video data and the still image data may be described in another file, and the source video determination unit 112 may acquire the place in which the source video data is placed by referring to the file.

<<File Structure>>

FIG. 4 is a view showing an example of the file structure of the still image data that is extracted from the video data and is saved. The extracted still image data according to the present embodiment includes a header 401, capturing information 402, capture source information 403, and image information 404. The header 401 is an area in which information indicating that the file is the still image data is recorded. The capturing information 402 is an area in which capturing conditions such as a shutter speed and an aperture value at the time of capturing are recorded. The capture source information 403 is an area in which the information (the file name or the like) on the source video data from which the still image data is extracted, and the extracted frame position information are recorded. The image information 404 is an area in which information such as the pixel value of the still image data or the like is recorded.

Note that, in the present embodiment, the information on the source video data from which the still image data is extracted and the extracted frame position information are recorded in the metadata, but the place in which the above information is recorded is not limited to the metadata. For example, the source video data information or the like may be recorded in the file name of the still image data or the like. In this case, the source video data information or the like may not be recorded in the metadata. Note that the place in which the information is recorded may differ from one piece of the source video data information or the extracted frame position information to another piece thereof.

Hereinafter, the description will be given by using “MOV_001.MOV” as the file name of the video data. In addition, it is assumed that the file name of the extracted still image data is “IMG_002.JPG”. Note that, in the metadata, information that the extracted frame is the first or last frame may be recorded. In addition, in the extracted still image data, the source video information (the file name or the like) and the extracted frame position are recorded in the area in which the metadata is recorded, as described above. Note that the file format (extension) of the still image is not limited to the JPG format, and may also be, e.g., GIF or PNG. In addition, the file format (extension) of the video is not limited to MOV, and may also be, e.g., WAV, MP4, or MPG.

<Image Editing Process>

An image editing process by the image processing apparatus 100 according to the present embodiment is performed by the each functional units of the control unit 110. The image editing process includes a display and editing process performed on the extracted still image data and a process in which a new frame is extracted from the video data and is subjected to the display and editing.

<<Still Image Editing Screen>>

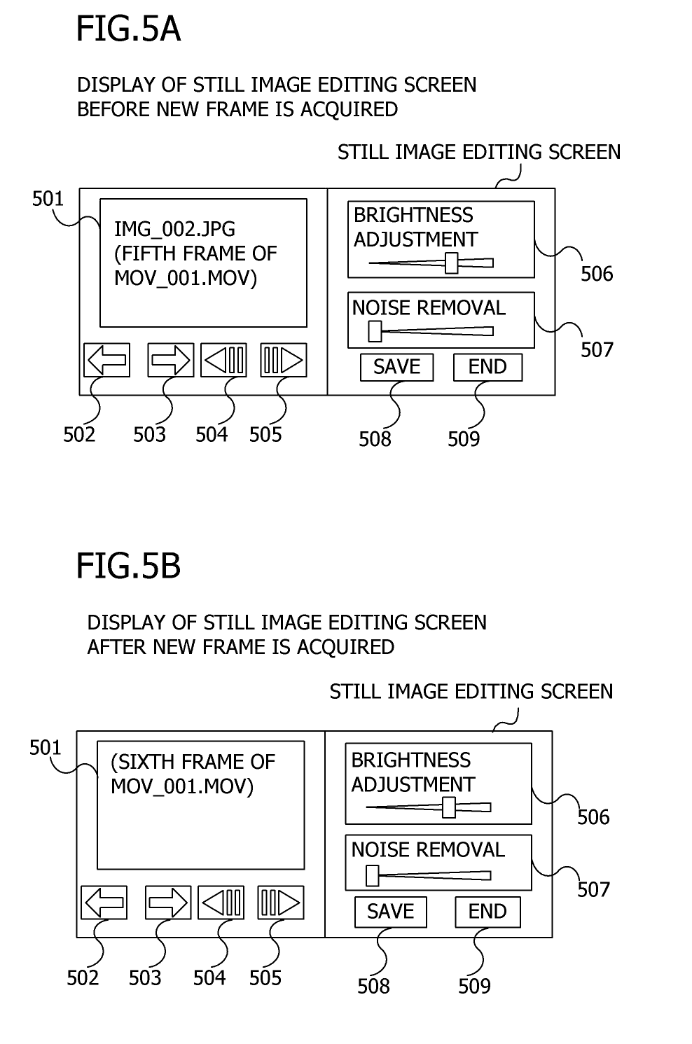

FIGS. 5A and 5B show the still image editing screen (GUI) for editing the still image data. FIG. 5A shows an example of the still image editing screen when the extracted still image data is read and edited, and FIG. 5B shows an example of the still image editing screen after the new frame is acquired.

A display area 501 is an area in which the edit subject still image data is displayed. The screen shown in FIG. 5A is the still image editing screen before the new frame is acquired, and hence the still image of the image file (IMG_002.JPG) is displayed in the display area 501.

An image forward button 502 and an image reverse button 503 are operation units for performing image forward/reverse that are used in a typical image editing application. When the user presses the image forward button 502 or the image reverse button 503 in the case where there are a plurality of pieces of still image (including third still image data) data, the control unit 110 switches the edit subject file.

Frame movement buttons 504 and 505 are operation units for receiving a frame movement instruction (frame acquisition instruction) of the user. Herein, the frame movement instruction of the user in the present embodiment is the instruction for acquiring the frame corresponding to the operation of the user from the capture-source video data of the display and edit subject image, and using the acquired frame as the display and edit subject frame. Specifically, the control unit 110 acquires a frame positioned a predetermined number of frames rearward or forward of the frame (display subject frame) corresponding to the still image displayed in the display area 501 from the video data in response to pressing of the frame movement button by the user, and uses the acquired frame as the display and edit subject frame.

Note that, when the display and edit subject image is not the still image data extracted from the video data, the control unit 110 disables or blanks the buttons. Further, even when the display and edit subject image is the still image data extracted from the video data, in the case where the still image data corresponds to the leading frame or end frame (inclusive of the vicinity thereof) in the video data, the control unit 110 disables or blanks the button for movement to the frame that cannot be acquired. Specifically, in the above case, the input reception unit 111 does not receive the frame movement instruction. Note that the frame movement buttons 504 and 505 may be always enabled. For example, in the case where the button is pressed in a situation in which the frame movement is not allowed as described above, the control unit 110 may end the new frame acquisition process, and display a message that the acquisition is not allowed on the still image editing screen.

Sliders 506 and 507 are operation units that perform brightness adjustment and noise removal that are used in a typical image editing application. The input reception unit 111 receives the adjustment of set parameters through the slider operation of the user. Subsequently, the image editing unit 115 performs image editing such as the brightness adjustment or the like according to the set parameters and issues an instruction to display the edited still image data in the display area 501, and the GUI control unit 116 switches the display in the display area 501 to the acquired still image according to the instruction.

Note that, in the present embodiment, the initial value of the set parameter adjustment is 0, but the initial value may also be a value other than 0. For example, the initial value may be the intermediate value of the set value, or the user may be able to set the initial value. Note that the editing process is not limited to the brightness adjustment and the noise removal. For example, the editing process related to contrast, sharpness, or gamma may be allowed. In addition, a means for setting the set parameter is not limited to the slider operation. A value indicative of the degree of adjustment of each set parameter may be directly input, or the adjustment of the set parameter may be performed by choosing preset choices.

A save button 508 is a button for saving the still image displayed in the display area 501 as data (overwrite save or save). An end button 509 is a button for ending the still image editing. For example, the user presses the end button 509 and the still image editing screen is thereby closed.

FIG. 5B shows the still image editing screen after the new frame is acquired. FIG. 5B shows an example in which the user presses the frame movement button 505, whereby the acquisition unit 114 acquires the frame immediately subsequent to the frame that is being edited from the video data, and the GUI control unit 116 switches the display in the display area 501 to the new frame. In this case, the still image extracted from the fifth frame of the video data (MOV_001.MOV) is displayed in FIG. 5A, and hence the still image data of the sixth frame from the beginning of the video data (MOV_001.MOV) is displayed in the display area 501. In the present embodiment, as shown in FIG. 5B, the set parameters adjusted by using the sliders 506 and 507 (the editing setting of the still image data displayed before display switching) are continuously used after the new frame is acquired. Note that the set parameters may not be continuously used and, for example, in the case where the new frame is displayed, the set parameters may be reset to the initial values.

<<Process Detail>>

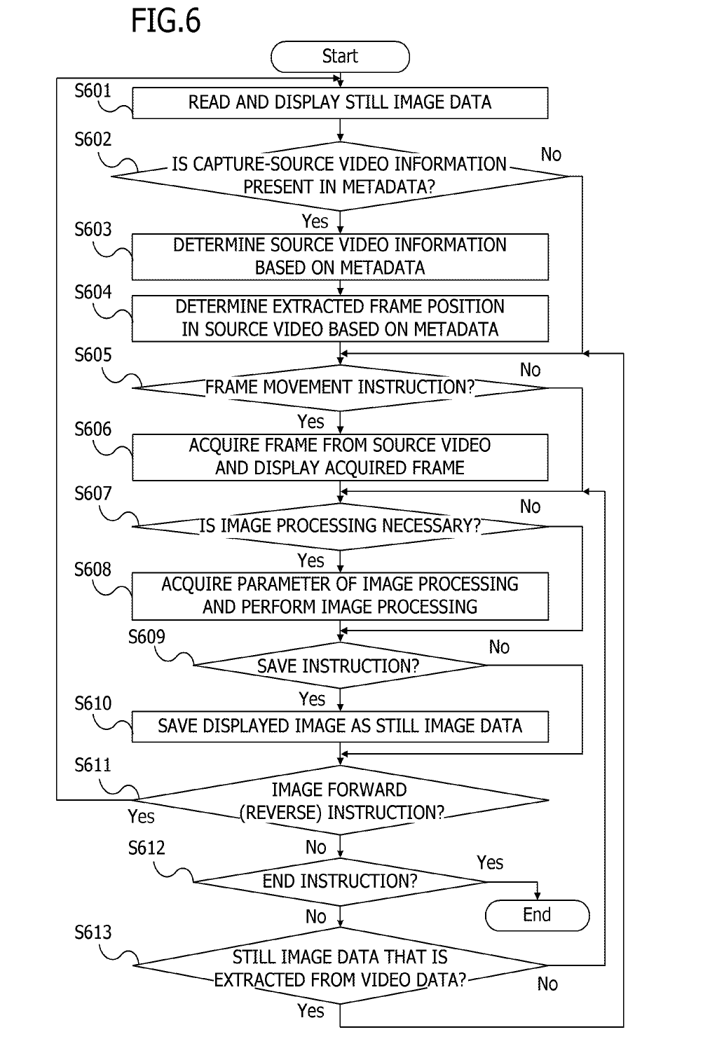

FIG. 6 is a flowchart showing an example of the image editing process including the new frame acquisition process according to the present embodiment. By using the flowchart in FIG. 6, a description will be given of an example in which, in the case where the source video information is added to the still image data, the corresponding frame is acquired from a source video file and is displayed according to the frame movement instruction of the user.

The user operates the operation unit 150 to issue an instruction to open the still image file, and the image editing process according to the present embodiment is thereby started. Specifically, the user opens the still image data (IMG_002.JPG) that is extracted from the video data and is saved on the image processing apparatus 100, and the process is thereby started. Note that the user opens the still image data other than the still image data that is extracted from the video data and is saved, and the present process may be thereby started.

In Step S601, the control unit 110 reads the still image data specified by the user, and displays the editing screen shown in FIG. 5A on the display unit 160. Specifically, when the input reception unit 111 receives read of the still image data, the image editing unit 115 issues an instruction to display the read still image data, and the GUI control unit 116 displays the read still image data in the display area 501. Subsequently, the control unit 110 determines whether or not the capture-source video information is added based on the metadata of the read still image data (S602). In the case where the control unit 110 determines that the source video information and the frame position information are not acquired (S602—NO), the control unit 110 does not receive the frame movement instruction to the input reception unit 111 by blanking or disabling the frame movement buttons. In the case where the control unit 110 determines that the capture-source video information is added (S602—YES), the process proceeds to Step S603.

In Step S603, the source video determination unit 112 determines the source video information based on the metadata of the still image data. In the present embodiment, the source video determination unit 112 determines the source video by acquiring the file name (MOV_001.MOV) of the source video data. Subsequently, the frame position determination unit 113 determines the extracted frame position information based on the metadata of the still image data (S604). In the example in FIG. 5A, the fifth frame from the beginning of the video file is determined to be the still image data by the frame position determination unit 113.

In Step S605, the control unit 110 determines whether or not the frame movement instruction has been issued. The input reception unit 111 receives the frame movement instruction in response to pressing of the frame movement button 504 or 505 in FIG. 5A. In the case where the control unit 110 determines that the frame movement instruction has been issued (S605—YES), the control unit 110 acquires the frame corresponding to the movement instruction of the user from the source video data of the read still image data, and displays the acquired frame (S606). In the example in FIG. 5A, in the case where the frame movement instruction is received in a state in which the still image data (IMG_002.JPG) is displayed, the acquisition unit 114 acquires the frame (sixth frame) immediately subsequent to the fifth frame from the beginning of the source video data (MOV_001.MOV). Subsequently, the GUI control unit 116 switches the display in the display area 501 to the acquired new frame. In the present embodiment, the set parameter of the image processing is not configured to be initialized when the new frame is acquired, and hence the set parameter is continuously used.

In Step S607, the control unit 110 determines whether or not the image processing is necessary. Specifically, the control unit 110 determines whether or not the image processing is necessary according to whether or not the values of the sliders 506 and 507 for the brightness adjustment and the noise removal shown in each of FIGS. 5A and 5B are changed from the initial values by the user. Subsequently, in the case where the control unit 110 determines that the image processing is necessary (S607—YES), the image editing unit 115 performs the image processing corresponding to the set parameters updated by using the sliders 506 and 507 (S608). Note that, in the case where the frame acquisition process described above is performed, the set parameters are continuously used, and the image editing unit 115 performs the image processing corresponding to the set parameters on the new frame acquired by the acquisition unit 114.

In Step S609, the control unit 110 determines whether or not the save instruction to save the displayed image that is issued by pressing the save button 508 shown in each of FIGS. 5A and 5B has been issued (S609). In the case where the control unit 110 determines that the save instruction has been issued (S609—YES), the image editing unit 115 saves the image that is displayed in the display area 501 shown in each of FIGS. 5A and 5B as the still image data (S610). In the case of the still image extracted from the video data, the image editing unit 115 saves the still image together with the frame position information of the displayed still image in the video data and the capture-source video information in the above save process. Note that the image editing unit 115 may save the image without adding the metadata to the image.

In Step S611, the control unit 110 determines whether or not an image forward or image reverse instruction has been issued. Specifically, when the input reception unit 111 receives the input according to the operation of the image forward button 502 or the image reverse button 503 by the user, the control unit 110 determines that the image forward or image reverse instruction has been issued. In the case where the control unit 110 determines that the image forward or image reverse instruction has been issued (S611—YES), the process proceeds to Step S601. In the case where the control unit 110 determines that the image forward or image reverse instruction is not issued (S611—NO), the process proceeds to Step S612.

In Step S612, the control unit 110 determines whether or not the end button 509 has been pressed. In the case where the control unit 110 determines that the end button has been pressed (S612—YES), the control unit 110 ends the image editing process. In the case where the control unit 110 determines that the end button is not pressed (S612—NO), the process proceeds to Step S613. In Step S613, the control unit 110 determines whether or not the source video information and the frame position information have been acquired. In the case where the control unit 110 determines that the source video information and the frame position information have been acquired (S613—YES), the process proceeds to Step S605. In the case where the control unit 110 determines that the source video information and the frame position information are not acquired (S613—NO), the process proceeds to Step S607.

### Advantageous Effects of Present Embodiment

In the case where the still image data obtained by extracting the frame from the video data and saving the frame is displayed and edited, it is possible to easily acquire the still image data (second still image data) of the new frame (second frame) in the video data and display and edit the still image data. With this, it is possible to avoid the trouble of reopening the source video data and extracting the frame again, and reduce the time and effort required for the user to perform the frame movement operation.

<Modification>

In the above embodiment, the example in which the capture source information is recorded in the metadata of the still image data extracted from the video data has been described, but the capture source information may be recorded in at least one of the metadata and the file name of the extracted still image data. In the case where the capture source information is recorded in the file name, the still image data may be generated with “(file name of capture-source video)+(extracted frame position). (extension)” used as the file name, and the capture source information may be acquired by referring to the file name. In addition, the capture source information may be managed in another file and read from the file.

In the above embodiment, in the case where the frame acquired based on the frame movement instruction is already extracted and saved as the still image data, the image processing apparatus 100 may display the still image data in the display area without newly acquiring the frame. In this case, the editing setting of the still image date is not continuously used and, e.g., the initial value can be used.

When the image processing result is saved after the still image data of the new frame extracted from the video data is acquired, the image processing result may be saved such that the initially opened still image file is overwritten, or a new file may be generated.

In the above embodiment, the example in which the image capturing apparatus and the image processing apparatus 100 are used has been described, but the above processing may be performed by using only the image capturing apparatus or the image processing apparatus 100.

(Others)

The present invention has been described thus far based on the preferred embodiments of the present invention. However, the present invention is not limited to the specific embodiments, and various embodiments without departing from the gist of the present invention are included in the present invention. In addition, portions of the embodiments described above may be appropriately combined with each other. Further, the present invention includes the case where a program of software for implementing the functions of the above embodiments is supplied to a system or an apparatus having a computer capable of executing the program directly from a recording medium or by using wired or wireless communication, and the program is executed. Consequently, program codes themselves that are supplied to and installed in a computer to allow the computer to implement the functions/processing of the present invention also implement the present invention. That is, a computer program for implementing the functions/processing of the present invention is included in the present invention. In this case, the program may take any form such as an object code, a program executed by an interpreter, or script data supplied to an OS as long as it has the function of the program. As a recording medium for supplying the program, for example, a magnetic recording medium such as a hard disk or a magnetic tape, an optical/magneto-optical recording medium, or a non-volatile semiconductor memory may be used. In addition, a method of supplying the program includes a method in which a computer program constituting the present invention is stored in a server on a computer network, and a client computer connected to the server downloads and executes the computer program.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-237052, filed on Dec. 11, 2017, which is hereby incorporated by reference herein in its entirety.

What is claimed is:

1. An image processing apparatus comprising:
a display control unit configured to perform control so as to display an image based on first still image data on a display unit, the first still image data being extracted from video data and saved;
a first determination unit configured to determine source video data, which is extraction source of the first still image data;
a second determination unit configured to determine a first frame position corresponding to the first still image data in the video data;
an input reception unit configured to receive an acquisition instruction to acquire second still image data of a second frame position in the video data, the second frame position being different from the first frame position; and
an acquisition unit configured to acquire the second still image data according to the acquisition instruction,
wherein the display control unit is further configured to switch the image to be displayed on the display unit to an image based on the second still image data in response to acquisition of the second still image data.

2. The image processing apparatus according to claim 1, further comprising:
an image editing unit configured to edit the first still image data, and to select the second still image as an editing target in a case where the second still image data is to be displayed on the display unit.

3. The image processing apparatus according to claim 2, wherein the image editing unit is further configured to continue to use an editing setting for the first still image data before switching, in a case where the second still image data is to be displayed by the display control unit.

4. The image processing apparatus according to claim 2, wherein the image editing unit is further configured to record source video information and the second frame position in at least one of metadata and a file name in a case where the second still image data is to be saved.

5. The image processing apparatus according to claim 1, wherein the acquisition instruction is an instruction to acquire still image data of a frame positioned a predetermined number of frames rearward or forward of a display target frame.

6. The image processing apparatus according to claim 5, wherein the input reception unit is further configured to receive a switching instruction to switch the image to be displayed in the display unit to third still image data.

7. The image processing apparatus according to claim 1, wherein the first determination unit is further configured to determine the source video data on the basis of at least one of metadata recorded in the first still image data and a file name of the first still image data.

8. The image processing apparatus according to claim 1, wherein the second determination unit is further configured to determine the first frame position on the basis of at least one of metadata recorded in the first still image data and a file name of the first still image data.

9. The image processing apparatus according to claim 1, wherein the input reception unit is configured not to receive the acquisition instruction from a user in a case where the first still image data is not still image data extracted from video data.

10. The image processing apparatus according to claim 1, wherein the input reception unit is configured not to receive the acquisition instruction to acquire a frame that cannot be acquired.

11. A control method of an image processing apparatus, the control method comprising:
performing control so as to display an image based on first still image data on a display unit, the first still image data being extracted from video data and saved;
determining source video data, which is extraction source of the first still image data;
determining a first frame position corresponding to the first still image data in the video data;
receiving an acquisition instruction to acquire second still image data of a second frame position in the video data, the second frame position being different from the first frame position;
acquiring the second still image data according to the acquisition instruction; and
switching the image to be displayed on the display unit to an image based on the second still image data in response to acquisition of the second still image data.

12. A non-transitory computer readable medium that stores a program, wherein the program causes a computer to execute: a control method of an image processing apparatus, the control method comprising:
performing control so as to display an image based on first still image data on a display unit, the first still image data being extracted from video data and saved;
determining source video data, which is extraction source of the first still image data;
determining a first frame position corresponding to the first still image data in the video data;
receiving an acquisition instruction to acquire second still image data of a second frame position in the video data, the second frame position being different from the first frame position;
acquiring the second still image data according to the acquisition instruction; and
switching the image to be displayed on the display unit to an image based on the second still image data in response to acquisition of the second still image data.
